(19) United States
(12) Patent Application Publication
(10) Pub. No.: US 2006/0206297 A1
(43) Pub. Date: Sep. 14, 2006

(54) Semiconductor designing apparatus

(76) Inventor: Yasuhiro Ishiyama, Otsu-shi (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/363,950

(22) Filed: Mar. 1, 2006

(30) Foreign Application Priority Data
Mar. 2, 2005 (JP) P.2005-057903

(51) Int. Cl. G06F 17/50

(52) U.S. Cl. 703/14

(57) ABSTRACT

There are provided a different part detecting portion for detecting the different part of the result of a simulation, a difference detecting portion for detecting a difference in the result of a simulation, an input different part display portion for displaying any of circuits having different simulation modes which has a difference, a different part display portion for displaying a circuit having a difference in the result of a simulation, a condition display portion for displaying, on a circuit diagram, an option to be used in a simulation, a record managing portion for managing the execution history of the result of a simulation, a condition checking portion for ascertaining whether or not a condition is accurately set in each circuit in the execution of a simulation, and a match checking portion for confirming the non-coincidence of the names and numbers of pins between the simulation modes.

### BACKGROUND OF THE INVENTION

1. Field of the Invention

The present invention relates to a semiconductor designing apparatus to be used for designing a semiconductor circuit.

2. Description of the Related Art

In the case in which a memory circuit or an analog circuit of a semiconductor is to be designed, heretofore, a function is verified digitally by utilizing a C language at the early stage of a design phase and an analog circuit simulation is carried out for each block by using SPICE when the design phase progresses. Thus, the design is verified.

In recent years, moreover, an analog/digital mixing simulator has been set to have a practical level, and analog and digital simulations can be mixed and carried out (for example, see Analog/Digital Mixing Simulator, Nikkei Electronics (10-14) Special issue, Nikkei BP Co., Ltd., Oct. 14, 1996, P. 120).

Consequently, a simulation mode to be used for each block corresponding to the progress of the design phase is selectively switched to be digital or analog, and the simulation of a whole circuit including each block can be carried out in a batch. Thus, an analog/digital mixing simulator is also used for the design of the memory circuit and the analog circuit.

A related function verifying technique basically executes a simulation in a simulation executing portion based on net list information of a circuit diagram and simulation input data. The technique according to the related art will be described below in detail.

FIG. 22 is a block diagram showing the structure of a related semiconductor designing apparatus, and 1 denotes an input portion, 2 denotes a CPU for processing information input from the input portion 1, 3 denotes a simulation executing portion for executing a simulation based on data processed in the CPU 2, and 4 denotes an output portion for outputting the result of the simulation executing portion 3.

FIG. 23 is a processing flow chart showing the operation of the semiconductor designing apparatus in FIG. 22. The CPU 2 allocates a simulation mode in each block based on a net list and simulation input data which are input to the input portion 1, and a simulation is executed in the simulation executing portion 3 and simulation output data are output from the output portion 4.

FIGS. 24 and 25 are diagrams for explaining the design phase of a circuit using the related semiconductor designing apparatus. FIG. 24A is a circuit diagram showing a circuit design phase 1 in which a chip A is constituted by a block A of an inverter which is described in a C language and a block B of the inverter which is described in the C language. FIG. 24 B shows the circuit description of the circuit design phase 1 in which both of the blocks A and B are described in the C language.

FIG. 25A is a circuit diagram showing a circuit design phase 2 in which the chip A is constituted by the block A of the inverter which is described in the C language and the block B of the inverter which is described in SPICE. FIG. 25B shows the circuit description of the circuit design phase 2 in which the block A is described in the C language and the block B is described in the SPICE.

In the design verification using the related semiconductor designing apparatus, first of all, the allocation of a simulation mode is carried out in each block by the CPU 2 based on the net list and the simulation input data which are input to the input portion 1.

In the examples of the circuits shown in FIGS. 24 and 25, the C language is allocated to the blocks A and B in the circuit design phase 1, and the C language is allocated to the block A and the SPICE is allocated to the block B in the circuit design phase 2.

Next, the simulation is executed in the simulation executing portion 3 corresponding to the simulation mode allocated in the CPU 2. As a result, simulation output data are output from the output portion 4.

In the related semiconductor designing apparatus, a simulation is carried out by selectively switching a simulation mode to be used in each block to be digital or analog corresponding to the progress of a design phase. In the case in which the results of the simulations are different from each other between the simulation modes, it is necessary to detect a different part in each block while seeing an output waveform. For this reason, there is a problem in that a long time is taken for detecting the different part.

In the case in which the simulation results are different from each other between the simulation modes, moreover, it is necessary to make a decision whether or not an allowable range is set while seeing the output waveform. For this reason, there is a problem in that a long time is taken for detecting a difference.

Furthermore, there is a problem in that the simulation mode to be used in each block cannot be confirmed on the circuit diagram before the execution of the simulation and the mode of a different simulation from an intended simulation is used without a confirmation.

In addition, in the case in which the simulation results are different from each other between the modes of the simulation during or after the execution of the simulation, it is impossible to confirm a circuit having the difference on the circuit diagram. For this reason, there is a problem in that a long time is taken for an analysis.

Moreover, option information about a simulation to be used in each simulation mode is present in the simulation input data. For the confirmation of any option to be used in each circuit block, it is necessary to confirm the simulation input data every circuit block. Therefore, there is a problem in that a long time is taken for the confirmation.

Although the simulation is carried out in various combinations corresponding to the progress of a design phase, furthermore, the execution history of the simulation and the different part of the simulation results are not managed. Consequently, there is a problem in that it is hard to manage the simulation results.

In addition, it is necessary to confirm the conditions of the circuit blocks each other based on the simulation input data in order to ascertain whether or not circuits to be used in the same design phase are mutually subjected to a simulation on the same condition. Therefore, there is a problem in that a long time is taken for the confirmation.

In the case in which whether the simulation is to be carried out on the same condition between the circuits before the execution of the simulation is not ascertained and the simulation is performed on different conditions between the circuits, moreover, there is a problem in that the simulation is wasted.

In the case in which the mismatching of the circuit is caused, for example, the names, numbers and orders of pins in the blocks are mismatched, furthermore, there is a problem in that the simulation is executed with the circuit used erroneously.

### SUMMARY OF THE INVENTION

It is an object of the invention to shorten a time taken for detecting a different part also in the case in which the results of the simulation are different from each other between the modes of the simulation when the simulation mode to be used in each block is selectively switched to be digital or analog corresponding to the progress of a design phase, thereby carrying out the simulation.

Moreover, it is an object of the invention to detect only a true error portion in a short time, thereby preventing the omission of the detection of a difference by a simulation executor also in the case in which the simulation results have a difference between the modes of the simulation, and shortening a time taken for making a decision whether the difference is set within an allowable range or not.

Furthermore, it is an object of the invention to confirm, over a circuit diagram, a simulation mode to be used in each block before the execution of the simulation and to prevent the execution of the simulation in an execution mode which is not intended before the execution of the simulation.

In addition, it is an object of the invention to confirm a circuit having a difference over a circuit diagram also in the case in which the results of a simulation have a difference between the modes of the simulation during or after the execution of the simulation, thereby shortening a time taken for analyzing the results of the simulation.

Moreover, it is an object of the invention to easily decide which option is used for each circuit block in each simulation mode, thereby preventing a simulation executing error.

Furthermore, it is an object of the invention to manage a state set in the execution of a simulation and the result of the simulation beyond mistake when carrying out the simulation in various combinations corresponding to the progress of a design phase.

In addition, it is an object of the invention to easily ascertain whether or not circuits used in the same design phase are mutually subjected to a simulation on the same conditions and whether or not the simulation is to be carried out on the same condition between the circuits before the execution of the simulation, thereby preventing the wasteful execution of the simulation.

Moreover, it is an object of the invention to prevent a simulation from being executed while using a circuit by mistake in the case in which the mismatching of the circuit is caused, for example, the names, numbers and orders of pins are mismatched in the circuit blocks.

The invention provides a semiconductor designing apparatus comprising an input portion which inputs data, a CPU which carries out a data processing, a simulation executing portion which executes a simulation of a circuit based on the data input from the input portion, a simulation database which stores a result of the execution of the simulation, and a different part detecting portion which detects a different part of the result of the simulation. According to the structure, it is not necessary to confirm the output waveforms of blocks by the executor of the simulation. Therefore, it is possible to shorten a time taken for detecting the different part. Incidentally, the different part detecting portion may detect the different part of the result of the simulation directly.

The invention provides a semiconductor designing apparatus comprising an input portion which inputs data, a CPU which carries out a data processing, a simulation executing portion which executes a simulation of a circuit based on the data input from the input portion, a simulation database which stores a result of the execution of the simulation, and a difference detecting portion which detects a difference in the result of the simulation. According to the structure, it is possible to detect only a true error portion. Therefore, it is possible to prevent the omission of the detection of the difference by the executor of the simulation and to shorten a time taken for deciding whether the difference is set within an allowable range or not.

The invention provides a semiconductor designing apparatus comprising an input portion which inputs data, a CPU which carries out a data processing, a simulation executing portion which executes a simulation of a circuit based on the data input from the input portion, a simulation database which stores a result of the execution of the simulation, and an input different part display portion which displays any of circuits having different simulation modes which has a difference. According to the structure, it is possible to prevent the execution of the simulation in an execution mode which is not intended before the execution of the simulation.

In the invention, there is provided a different part display portion which displays a circuit having a difference in the result of the simulation which is detected by the different part detecting portion. According to the structure, it is possible to easily confirm the different parts of the results of the simulation between simulation modes over a circuit diagram during or after the execution of the simulation. Therefore, it is possible to shorten a time taken for analyzing the result of the simulation.

The invention provides a semiconductor designing apparatus comprising an input portion which inputs data, a CPU which carries out a data processing, a simulation executing portion which executes a simulation of a circuit based on the data input from the input portion, a simulation database which stores a result of the execution of the simulation, and a condition display portion which displays, on a circuit diagram, an option to be used in the simulation. According to the structure, it is easy to visually decide which option is used in each circuit block. Therefore, it is possible to prevent a simulation executing error.

The invention provides a semiconductor designing apparatus comprising an input portion which inputs data, a CPU which carries out a data processing, a simulation executing portion which executes a simulation of a circuit based on the data input from the input portion, a simulation database which stores a result of the execution of the simulation, and a record managing portion which manages an execution history of the result of the simulation and a different part of the result of the simulation. According to the structure, even if the simulation mode is used in various combinations for each circuit block, it is possible to manage a state set in the execution of the simulation and the result beyond mistake.

The invention provides a semiconductor designing apparatus comprising an input portion which inputs data, a CPU which carries out a data processing, a simulation executing portion which executes a simulation of a circuit based on the data input from the input portion, a simulation database which stores a result of the execution of the simulation, and a condition checking portion which ascertains whether or not a condition is accurately set in the execution of the simulation in each circuit before the execution of the simulation. According to the structure, it is possible to previously ascertain whether or not the circuits to be used in the same design phase are mutually subjected to the simulation on the same condition. Therefore, it is possible to prevent the execution of the simulations in which the simulation conditions are not coincident with each other.

The invention provides a semiconductor designing apparatus comprising an input portion which inputs data, a CPU which carries out a data processing, a simulation executing portion which executes a simulation of a circuit based on the data input from the input portion, a simulation database which stores a result of the execution of the simulation, and a match checking portion which ascertains whether or not names and numbers of pins are coincident with each other in circuit blocks before the execution of the simulation. According to the structure, it is possible to prevent the execution of the simulation in a state in which the circuits are different from each other, for example, the names, numbers and orders of the pins are different from each other.

According to the invention, when the simulation mode to be used in each block is selectively switched to be digital or analog corresponding to the progress of a design phase, thereby carrying out the simulation, the different part of the result of the simulation is detected between the modes of the simulation. Consequently, it is possible to produce an advantage that the executor of the simulation does not need to confirm the output waveforms of the blocks and a time taken for detecting the different part can be thus shortened.

According to the invention, moreover, it is possible to detect only a true error portion by detecting a difference for the different part of the result of a simulation between the simulation modes. Consequently, there is an advantage that it is possible to prevent the omission of the detection of the difference from being caused by the executor of the simulation and to shorten a time taken for deciding whether the difference is set within an allowable range or not.

According to the invention, furthermore, it is possible to confirm, over a circuit diagram, the simulation mode to be used in each block before the execution of the simulation. Consequently, there is an advantage that it is possible to prevent the execution of the simulation in an execution mode which is not intended before the execution of the simulation.

According to the invention, moreover, it is possible to confirm the different part of the result of a simulation between the simulation modes over a circuit diagram during or after the execution of the simulation. Consequently, there is an advantage that it is possible to shorten a time taken for analyzing the result of the simulation.

According to the invention, furthermore, option information about a simulation to be used in each simulation mode is displayed on the circuit diagram of each circuit block. Consequently, there is an advantage that it is possible to visually decide which option is used in each circuit block, thereby preventing a simulation executing error.

According to the invention, moreover, the execution history of the simulation and the different part of the result of the simulation are managed. Consequently, there is an advantage that it is possible to manage a state set in the execution of a simulation and a result beyond mistake even if the simulation mode is used in various combinations for each circuit block.

According to the invention, furthermore, it is possible to previously ascertain whether circuits to be used in the same design phase are mutually subjected to a simulation on the same condition by checking the condition of the simulation for each block before the execution of the simulation. Therefore, there is an advantage that it is possible to prevent the execution of a simulation in which the conditions of the simulation are not coincident with each other.

According to the invention, moreover, the mismatched portion of a circuit is detected between circuit blocks. Consequently, there is an advantage that it is possible to prevent the execution of a simulation in a state in which the names, numbers and orders of pins are different from each other.

### BRIEF DESCRIPTION OF THE DRAWINGS

FIG. 1 is a block diagram showing the structure of a semiconductor designing apparatus according to an embodiment of the invention;

FIG. 2 is a processing flow chart showing the operation of a different part detecting portion according to the embodiment of the invention;

FIG. 3 is a diagram for explaining the design phase of a circuit according to the embodiment of the invention;

FIG. 4 is a diagram for explaining the design phase of the circuit according to the embodiment of the invention;

FIG. 5 is a processing flow chart showing the operation of a difference detecting portion according to the embodiment of the invention;

FIG. 6 is a diagram for explaining the design phase of the circuit according to the embodiment of the invention;

FIG. 7 is a diagram for explaining the design phase of the circuit according to the embodiment of the invention;

FIG. 8 is a processing flow chart showing the operation of an input different part display portion according to the embodiment of the invention;

FIG. 9 is a diagram for explaining the design phase of the circuit according to the embodiment of the invention;

FIG. 10 is a processing flow chart showing the operation of a different part display portion according to the embodiment of the invention;

FIG. 11 is a diagram for explaining the design phase of the circuit according to the embodiment of the invention;

FIG. 12 is a processing flow chart showing the operation of a condition display portion according to the embodiment of the invention;

FIG. 13 is a diagram for explaining the design phase of the circuit according to the embodiment of the invention;

FIG. 14 is a processing flow chart showing the operation of a record managing portion according to the embodiment of the invention;

FIG. 15 is a diagram for explaining an example of record information about an execution history according to the embodiment of the invention;

FIG. 16 is a processing flow chart showing the operation of a condition checking portion according to the embodiment of the invention;

FIG. 17 is a diagram for explaining an example of a condition check according to the embodiment of the invention;

FIG. 18 is a processing flow chart showing the operation of a match checking portion according to the embodiment of the invention;

FIG. 19 is a diagram for explaining match checking according to the embodiment of the invention;

FIG. 20 is a diagram for explaining the match checking according to the embodiment of the invention;

FIG. 21 is a diagram for explaining the match checking according to the embodiment of the invention;

FIG. 22 is a block diagram showing the structure of a related semiconductor designing apparatus;

FIG. 23 is a processing flow chart showing the operation of the related semiconductor designing apparatus;

FIG. 24 is a diagram for explaining the design phase of a circuit according to a related embodiment; and

FIG. 25 is a diagram for explaining the design phase of the circuit according to the related embodiment.

### DETAILED DESCRIPTION OF THE PREFERRED EMBODIMENTS

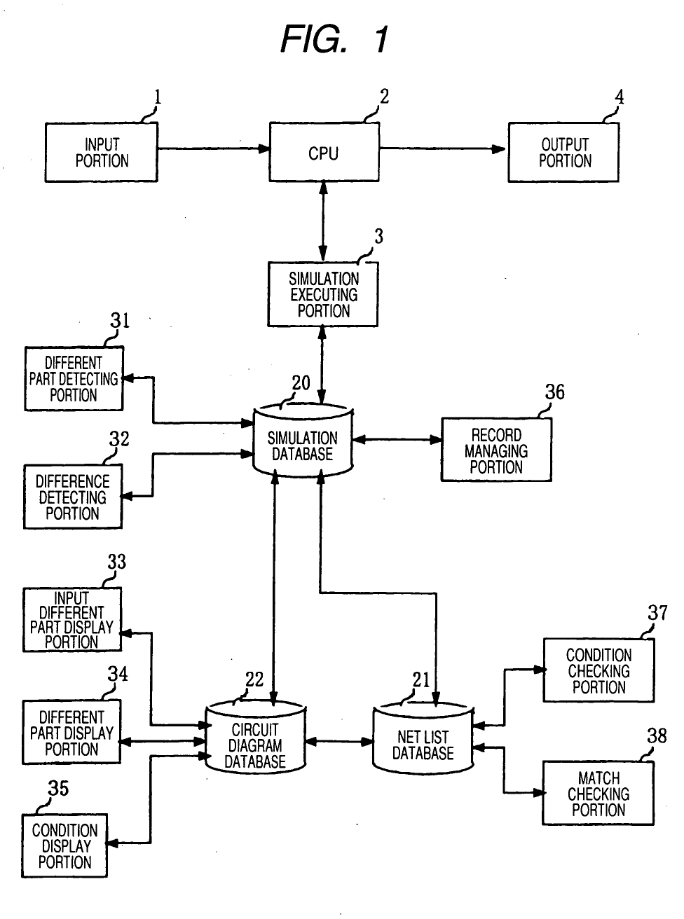

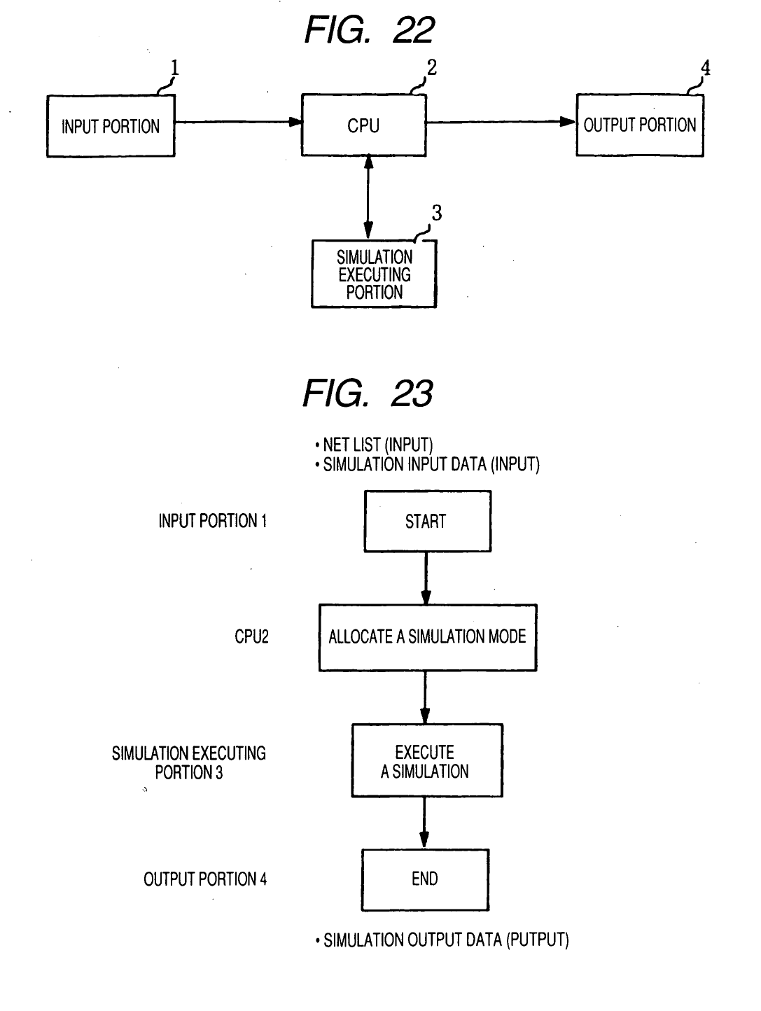

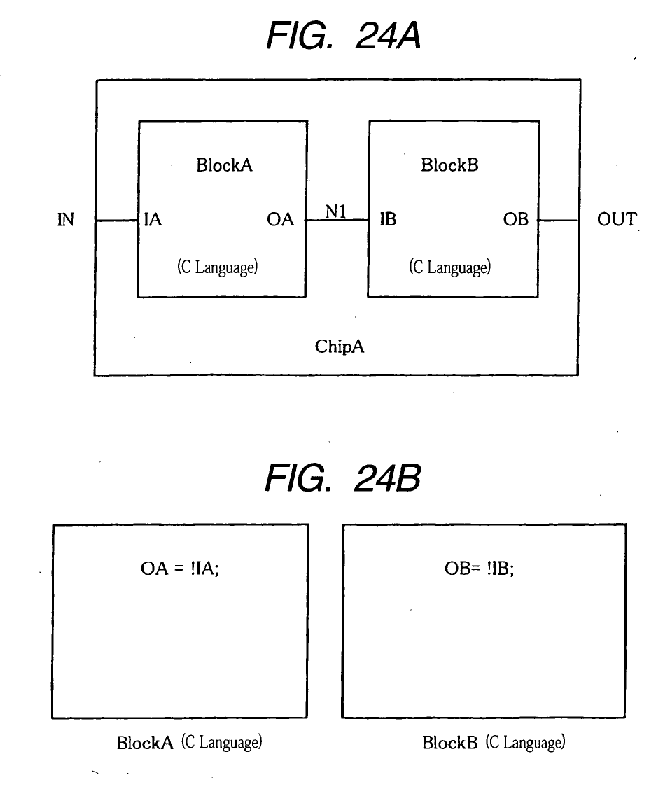

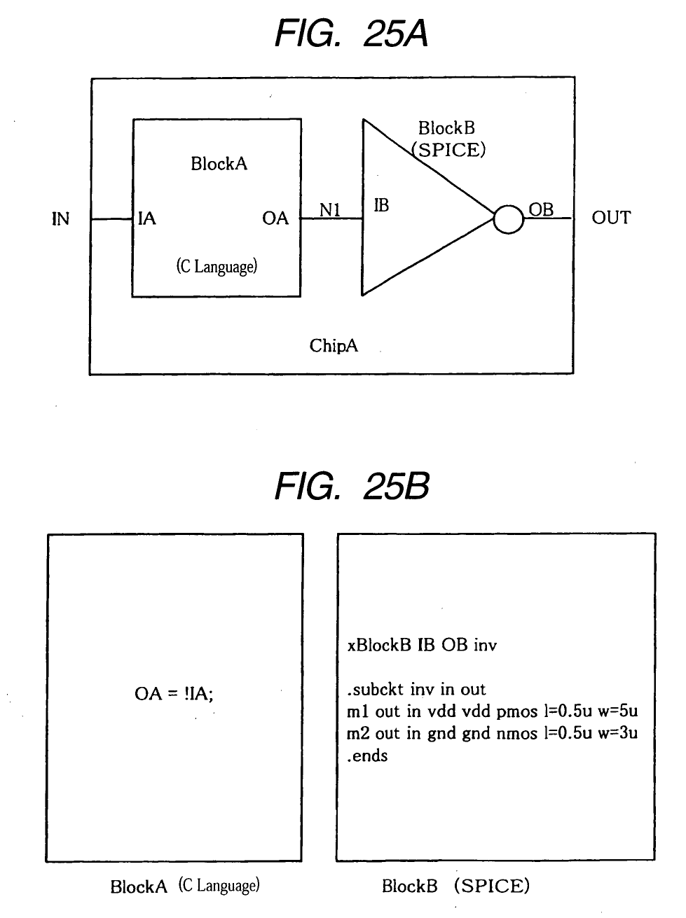

An embodiment of the invention will be described below with reference to the drawings. FIG. 1 is a block diagram showing the structure of a semiconductor designing apparatus according to an embodiment of the invention. In FIG. 1, 1 denotes an input portion, 2 denotes a CPU, 3 denotes a simulation executing portion, and 4 denotes an output portion, and these have the same structures as those in FIG. 22.

In FIG. 1, furthermore, 20 denotes a simulation database, 21 denotes a net list database, 22 denotes a circuit diagram database, 31 denotes a different part detecting portion, 32 denotes a difference detecting portion, 33 denotes an input different part display portion, 34 denotes a different part display portion, 35 denotes a condition display portion, 36 denotes a record managing portion, 37 denotes a condition checking portion, and 38 denotes a match checking portion.

The simulation database 20 stores the processing result of a simulation, the net list database 21 stores a net list for carrying out a simulation, and the circuit diagram database 22 stores a circuit diagram for carrying out a simulation.

The different part detecting portion 31 detects the different part of the result of a simulation, the difference detecting portion 32 detects a difference between the results of a simulation, the input different part display portion 33 displays a circuit having a difference between circuits in different simulation modes which is input from the input portion 1, the different part display portion 34 displays a circuit having a difference between the results of a simulation which is detected by the different part detecting portion 31, and the condition display portion 35 displays, on a circuit diagram, an option to be used in a simulation which is input from the input portion 1.

The record managing portion 36 manages the execution history of the result of a simulation, the condition checking portion 37 ascertains whether or not a condition is set accurately in the execution of a simulation in each circuit before the execution of the simulation, and the match checking portion 38 ascertains whether or not the names and numbers of pins are coincident with each other between the modes of the simulation before the execution of the simulation.

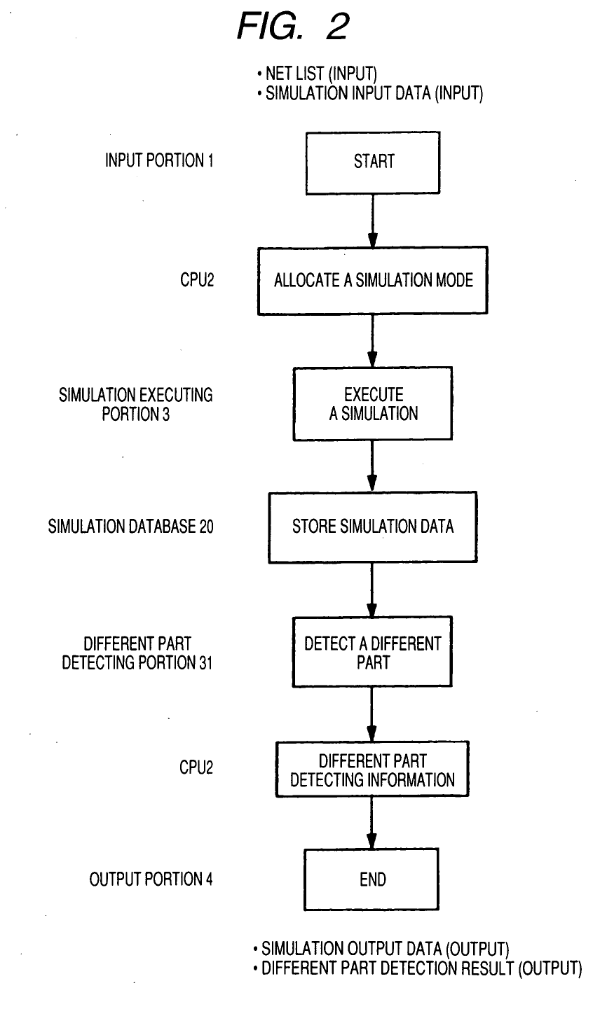

The function and operation of each portion according to the embodiment will be described below in order. FIG. 2 is a processing flow chart showing the operation of the different part detecting portion 31 according to the embodiment. The CPU 2 selects input data from a net list and simulation input data which are input to the input portion 1 and allocates a simulation mode in each block, and the simulation executing portion 3 executes the simulation.

Simulation data are stored in the simulation database 20 by the execution of the simulation, and the different part of the simulation is detected by the different part detecting portion 31. Next, the different part detecting information of the simulation is selectively synthesized by the CPU 2, and simulation output data and a different part detection result are output from the output portion 4.

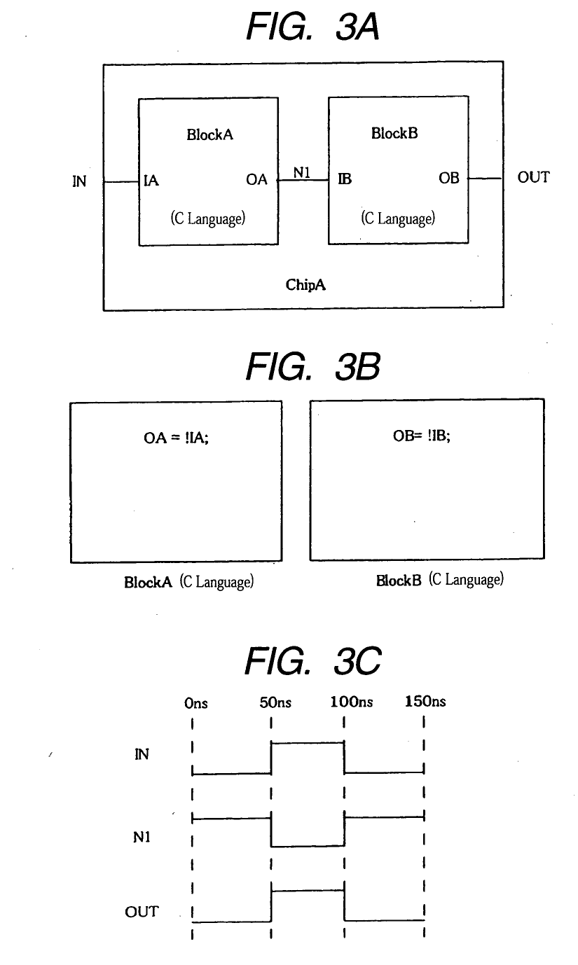

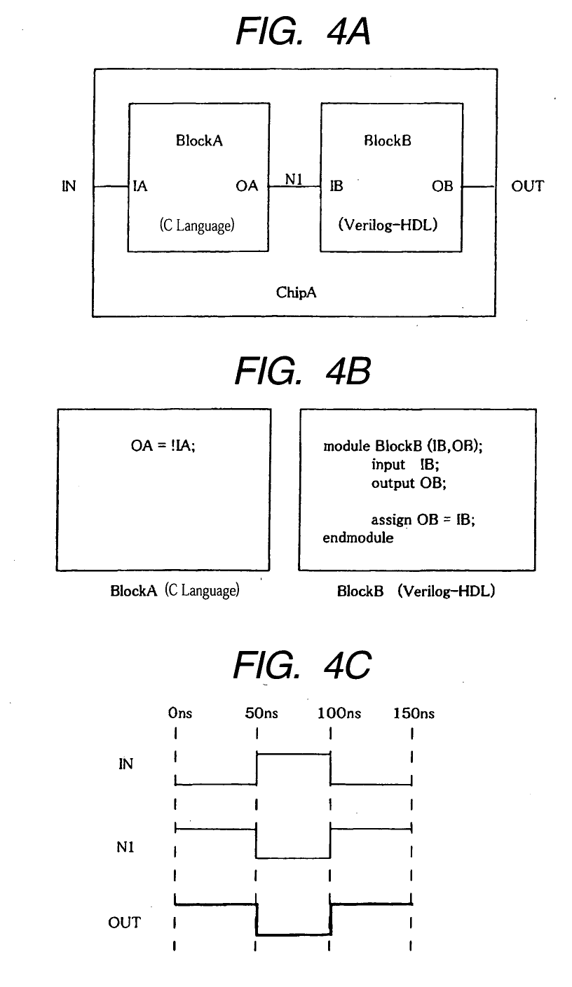

FIGS. 3 and 4 are diagrams for explaining the design phase of the circuit according to the embodiment. FIG. 3A is a circuit diagram showing a circuit design phase 1 in which a chip A is constituted by a block A of an inverter which is described in a C language and a block B of the inverter which is described in the C language. FIG. 3B shows the circuit description of the circuit design phase 1 in which both the block A and the block B are described in the C language. FIG. 3C shows the simulation waveform of the circuit design phase 1.

FIG. 4A is a circuit diagram showing a circuit design phase 2 in which the chip A is constituted by the block A of the inverter which is described in the C language and the block B of a buffer which is described in Verilog-HDL. FIG. 4B shows the circuit description of the circuit design phase 2 in which the block A is described in the C language and the block B is described in the Verilog-HDL. FIG. 3C shows the simulation waveform of the circuit design phase 2. Since a different waveform from that of the circuit design phase 1 in FIG. 3 is detected, a state is shown in a heavy line.

Thus, the structure of the block B is varied between the design phases of the circuit. However, the different part detecting portion 31 is provided so that the different part of the result of the simulation is detected. Consequently, it is possible to easily confirm the output waveforms of the blocks and to shorten a time taken for detecting a different part.

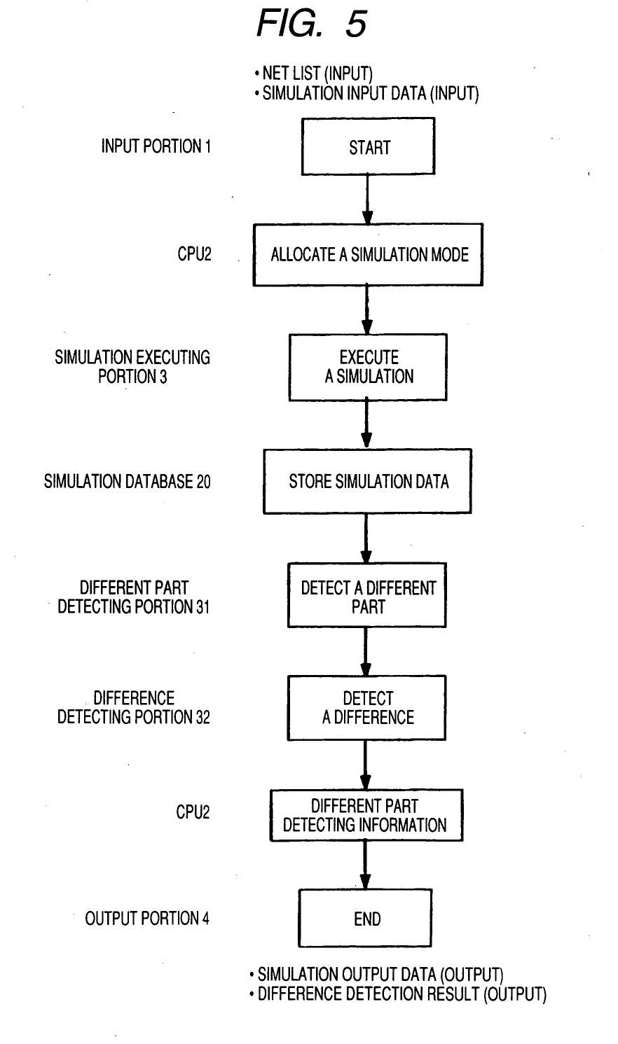

FIG. 5 is a processing flow chart showing the operation of the difference detecting portion 32 according to the embodiment. The CPU 2 selects input data from the net list and the simulation input data which are input to the input portion 1, and a simulation mode is allocated in each block and a simulation is executed by the simulation executing portion 3.

The simulation data are stored in the simulation database 20 by the execution of the simulation, the different part of the simulation is detected by the different part detecting portion 31, and furthermore, a difference in the simulation is detected by the difference detecting portion 32. Next, the CPU 2 selectively synthesizes the difference detecting information of the simulation, and simulation output data and a difference detection result are output from the output portion 4.

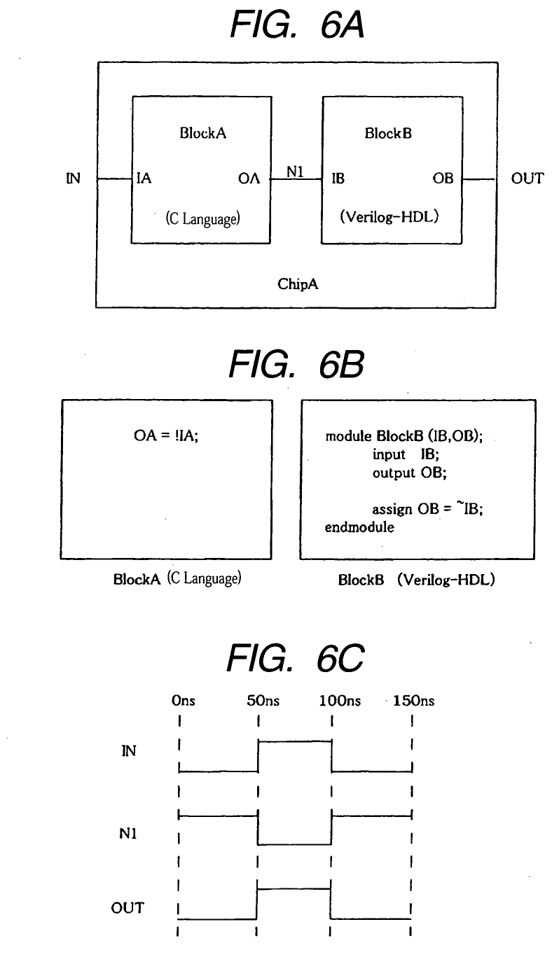

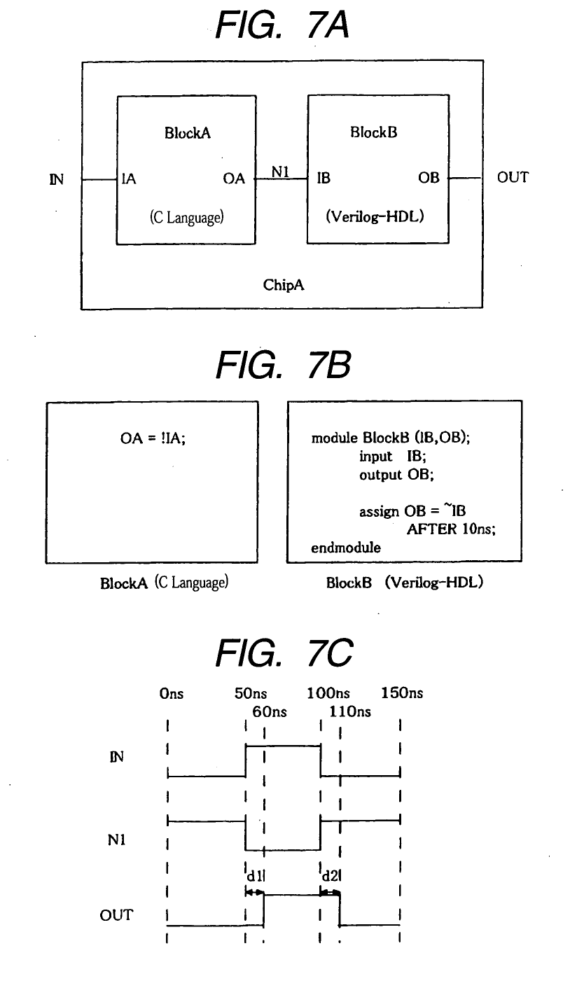

FIGS. 6 and 7 are diagrams for explaining the design phase of the circuit according to the embodiment. FIG. 6A is a circuit diagram showing a first simulation in the circuit design phase 2 in which the chip A is constituted by the block A of the inverter which is described in the C language and the block B of the inverter which is described in the Verilog-HDL. FIG. 6B shows the circuit description of the first simulation in the circuit design phase 2 in which the block A is described in the C language and the block B is described in the Verilog-HDL. FIG. 6C shows the simulation waveform of the first simulation in the circuit design phase 2.

FIG. 7A is a circuit diagram showing a second simulation in the circuit design phase 2 in which the chip A is constituted by the block A of the inverter which is described in the C language and the block B of the inverter which is described in the Verilog-HDL. FIG. 7B shows the circuit description of the second simulation in the circuit design phase 2 in which the block A is described in the C language and the block B is described in the Verilog-HDL.

Although the delay values of outputs are not set to both the block A and the block B in the first simulation, an output delay of 10 ns is given to the block B in the second simulation. FIG. 7C shows the simulation waveform of the second simulation in the circuit design phase 2, illustrating a state in which 10 ns is detected to be a difference for the first simulation in d1 and d2 at the outputs.

By providing the difference detecting portion 32 for detecting the difference between the results of the simulation, thus, it is possible to detect only a true different part between the first simulation and the second simulation. Therefore, it is possible to prevent the omission of the detection of the difference by the executor of the simulation, and furthermore, to shorten a time taken for making a decision whether the difference is set within an allowable range or not.

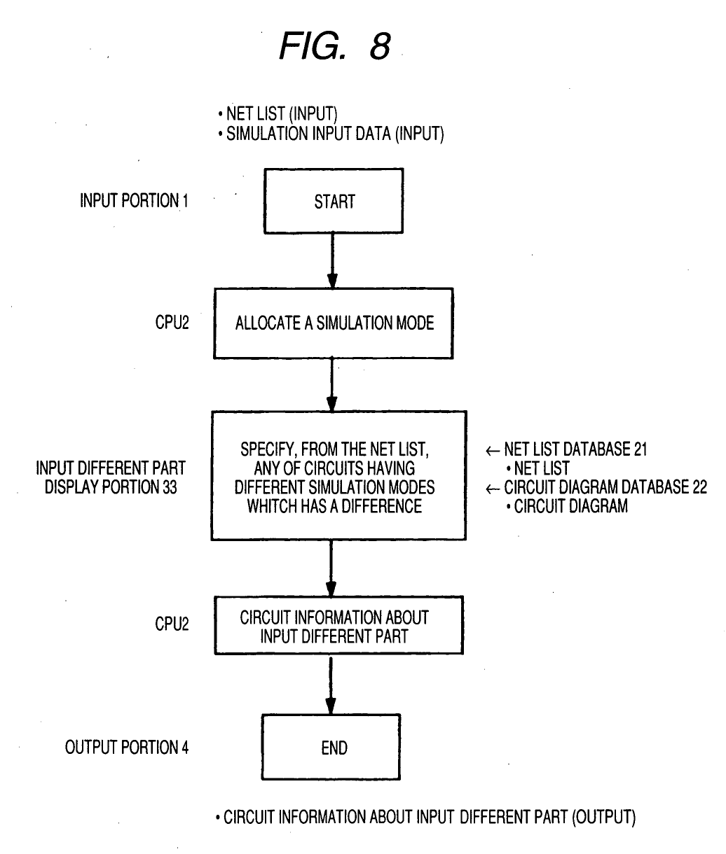

FIG. 8 is a processing flow chart showing the operation of the input different part display portion 33 according to the embodiment. The CPU 2 selects input data from a net list and simulation input data which are input to the input portion 1 and allocates a simulation mode in each block.

Next, a circuit having a difference between circuits in different simulation modes is specified from the net list by the input different part display portion 33 for the net list database 21 for storing a net list to carry out a simulation and the circuit diagram database 22 for storing a circuit diagram. Next, circuit information about an input different part is selectively synthesized by the CPU 2 and is output from the output portion 4.

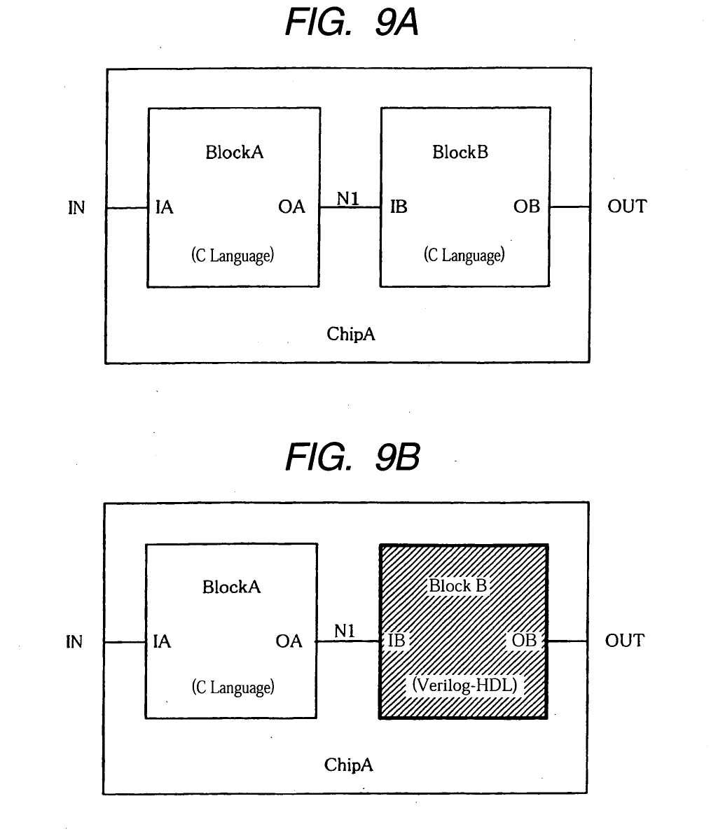

FIG. 9 is a diagram for explaining the design phase of the circuit according to the embodiment. FIG. 9A is a circuit diagram showing the circuit design phase 1 in which the chip A is constituted by the block A described in the C language and the block B described in the C language. FIG. 9B shows the circuit description of the circuit design phase 2 in which the chip A is constituted by the block A described in the C language and the block B described in the Verilog-HDL.

The block B is described in the language C in the circuit design phase 1 and the Verilog-HDL in the circuit design phase 2. For this reason, an input is different so that the block B is highlighted and displayed.

By providing the input different part display portion 33 for displaying a circuit having a difference in circuits in different simulation modes input from the input portion, thus, it is possible to prevent the execution of the simulation in an executing mode which is not intended before the execution of the simulation.

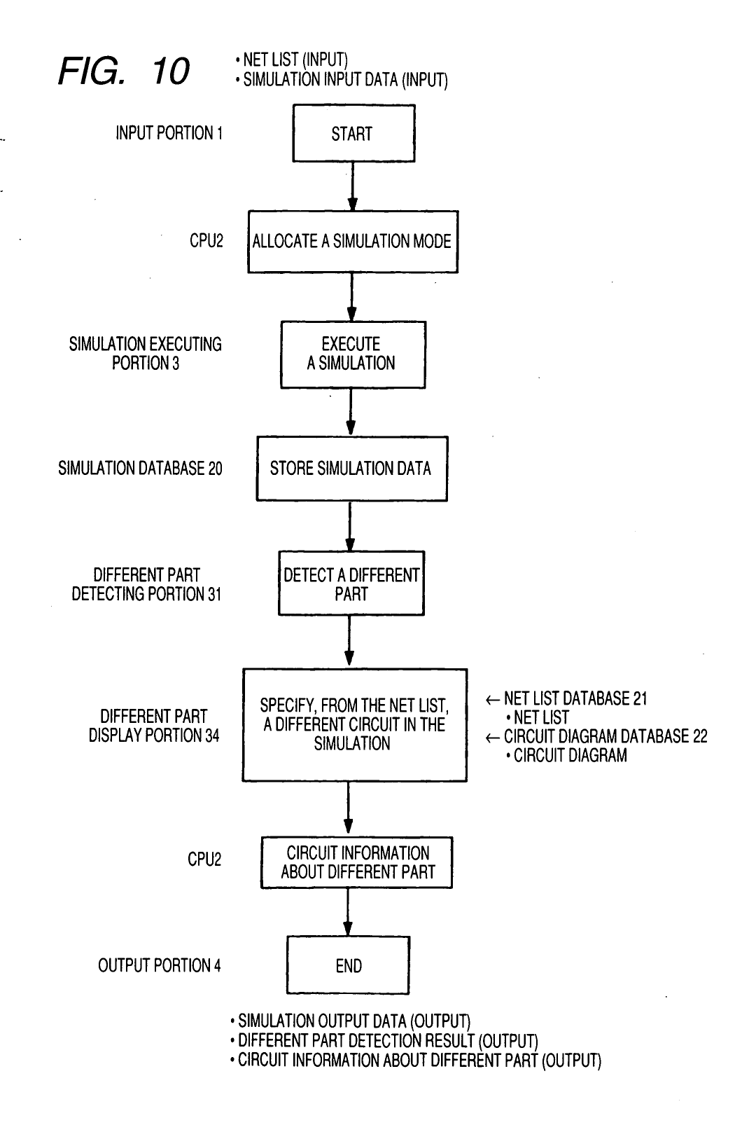

FIG. 10 is a processing flow chart showing the operation of the different part display portion 34 according to the embodiment. The CPU 2 selects input data from the net list and the simulation input data which are input to the input portion 1 and allocates the simulation mode in each block. Next, the simulation is executed by the simulation executing portion 3 and the simulation data are stored in the simulation database 20.

Furthermore, the different part is detected by the different part detecting portion 31 and a circuit having a different simulation result is specified from the net list by the different part display portion 34 for the net list database 21 for storing the net list to carry out a simulation and the circuit diagram database 22 for storing the circuit diagram. Next, circuit information about the different part is selectively synthesized by the CPU 2, and the simulation output data, the different part detection result and the circuit information about the different part are output from the output portion 4.

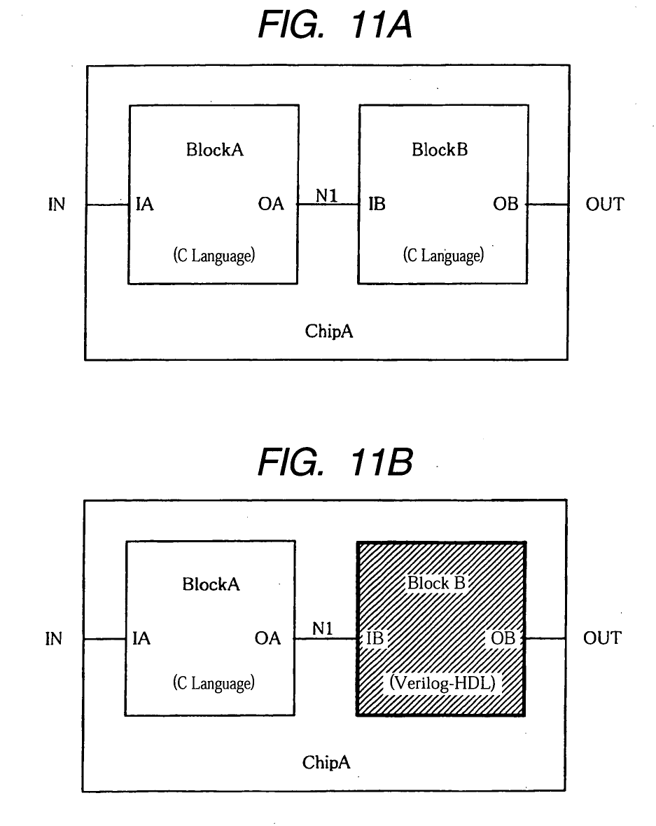

FIG. 11 is a diagram for explaining the design phase of the circuit according to the embodiment. FIG. 11A is a circuit diagram showing the circuit design phase 1 in which the chip A is constituted by the block A described in the C language and the block B described in the C language. FIG. 11B shows the circuit description of the circuit design phase 2 in which the chip A is constituted by the block A described in the C language and the block B described in the Verilog-HDL.

The block B is described in the C language in the circuit design phase 1 and the Verilog-HDL in the circuit design phase 2. For this reason, the states of the block B which are brought during or after the execution of the simulation are different from each other, and the block B is highlighted and displayed.

By providing the different part display portion 34 for displaying a circuit having a difference between the simulation results detected by the different part detecting portion 31, thus, it is possible to shorten a time taken for analyzing the simulation results.

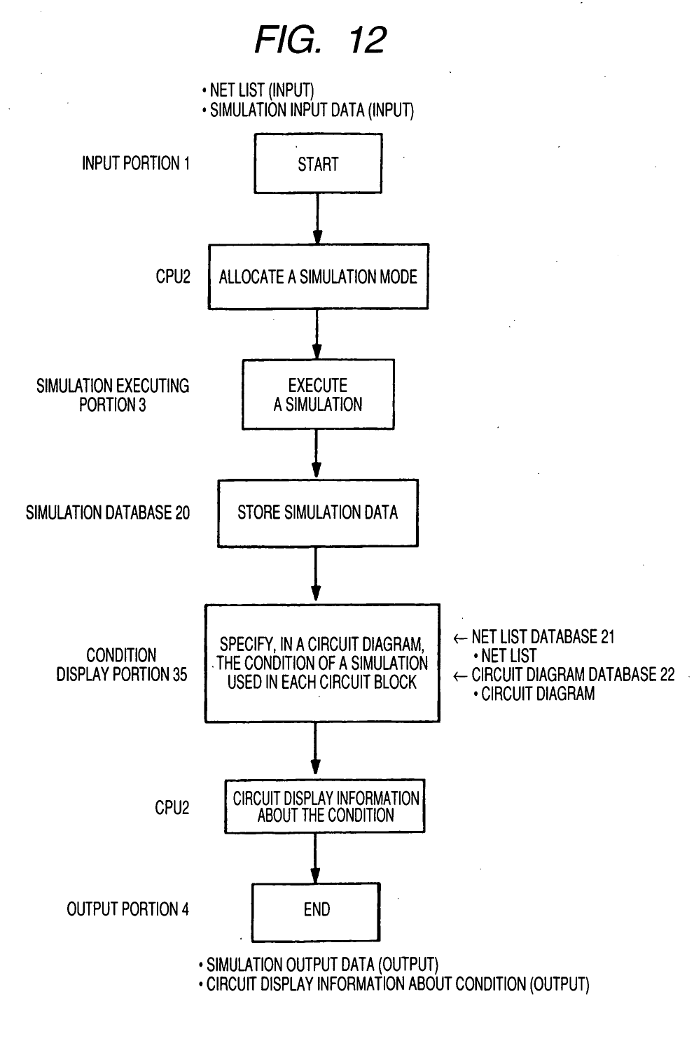

FIG. 12 is a processing flow chart showing the operation of the condition display portion 35 according to the embodiment. The CPU 2 selects input data from the net list and the simulation input data which are input to the input portion 1 and allocates the simulation mode in each block. Next, the simulation is executed by the simulation executing portion 3 and the simulation data are stored in the simulation database 20.

Next, a simulation condition used in each block is specified in a circuit diagram by the condition display portion 35 for the net list database 21 for storing a net list to carry out a simulation and the circuit diagram database 22 for storing a circuit diagram. Furthermore, the CPU 2 selectively synthesizes circuit display information about the simulation condition, and simulation output data and circuit display information about a condition are output from the output portion 4.

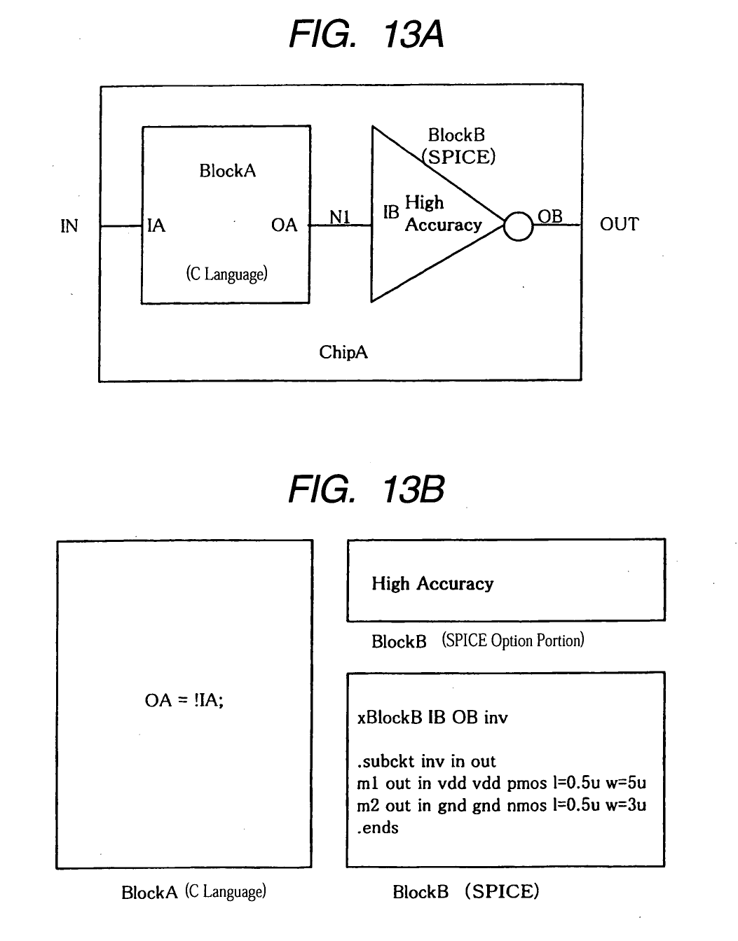

FIG. 13 is a diagram for explaining the design phase of the circuit according to the embodiment. FIG. 13A is a circuit diagram showing a circuit design phase 3 in which the chip A is constituted by the block A of the inverter which is described in the C language and the block B of the inverter which is described in SPICE. FIG. 13B shows the circuit description of the circuit design phase 3 in which the chip A is constituted by the block A described in the C language and the block B described in the SPICE.

The option of the SPICE used in the block B is High Accuracy. For this reason, High Accuracy to be the option of the SPICE is displayed in the circuit diagram of the block B.

By providing the condition display portion 35 for displaying, on the circuit diagram, the option to be used in the simulation input from the input portion, thus, it is possible to visually decide which option is used for each circuit block. Therefore, it is possible to prevent a simulation executing error.

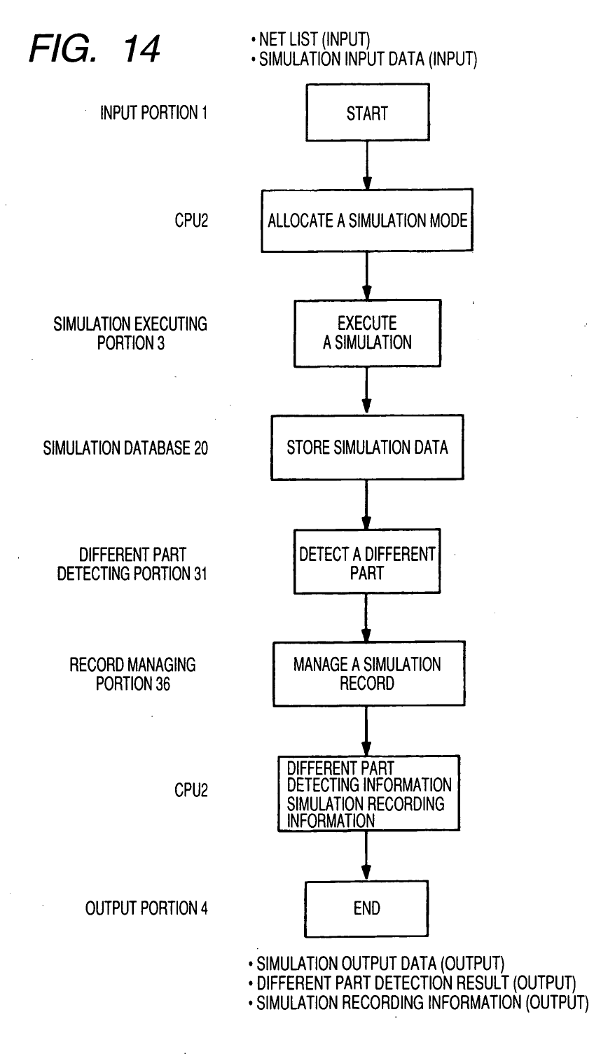

FIG. 14 is a processing flow chart showing the operation of the record managing portion 36 according to the embodiment. The CPU 2 selects input data from the net list and the simulation input data which are input to the input portion 1 and allocates the simulation mode in each block. Next, the simulation is executed by the simulation executing portion 3 and the simulation data are stored in the simulation database 20.

Next, a different part is detected by the different part detecting portion 31 and simulation record information is recorded on the record managing portion 36. Furthermore, the simulation record information and different part detecting information are selectively synthesized by the CPU 2, and simulation output data, the different part detecting information and the simulation record information are output from the output portion 4.

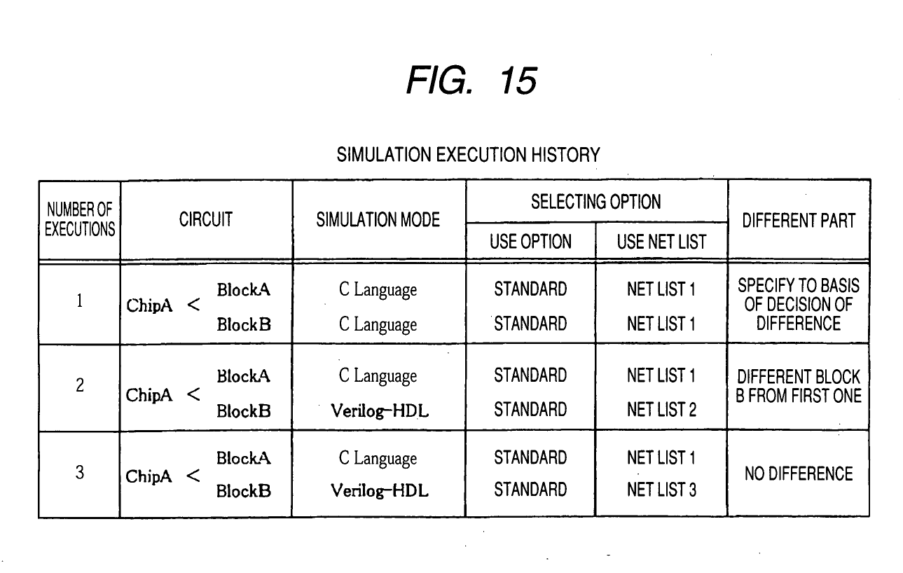

FIG. 15 is a diagram for explaining an example of record information about an execution history according to the embodiment, in which a circuit for each number of executions of a simulation, a simulation mode, the execution history of the selecting option of a simulation, and a different part are described.

Herein, there is shown an example in which a simulation is executed with the structures of FIGS. 3, 4 and 6 for first, second and third simulations, respectively. In the case in which a decision is made on the basis of the structure of a circuit in the execution of the first simulation, the block B in the second simulation is different from that in the first simulation and is the same as that in the third simulation.

By providing the record managing portion 36 for managing the execution history of the simulation result, thus, it is possible to manage a state brought in the execution of the simulation and a result beyond mistake even if a simulation mode is used in various combinations for each circuit block.

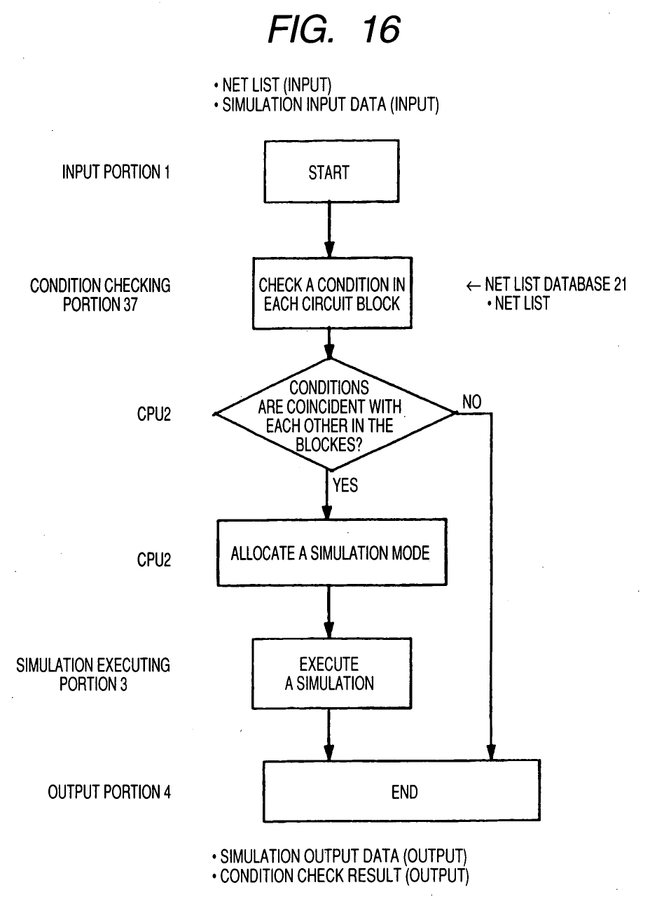

FIG. 16 is a processing flow chart showing the operation of the condition checking portion 37 according to the embodiment. The condition checking portion 37 checks a condition in each circuit block for a net list and simulation input data which are input to the input portion 1.

In the case in which the conditions are coincident with each other in the blocks, the CPU 2 allocates the simulation mode in each of the blocks, the simulation executing portion 3 executes the simulation, and simulation output data and a condition check result are output from the output portion 4. In the case in which the conditions are not coincident with each other in each of the blocks, the simulation is not carried out but the condition check result is output from the output portion 4.

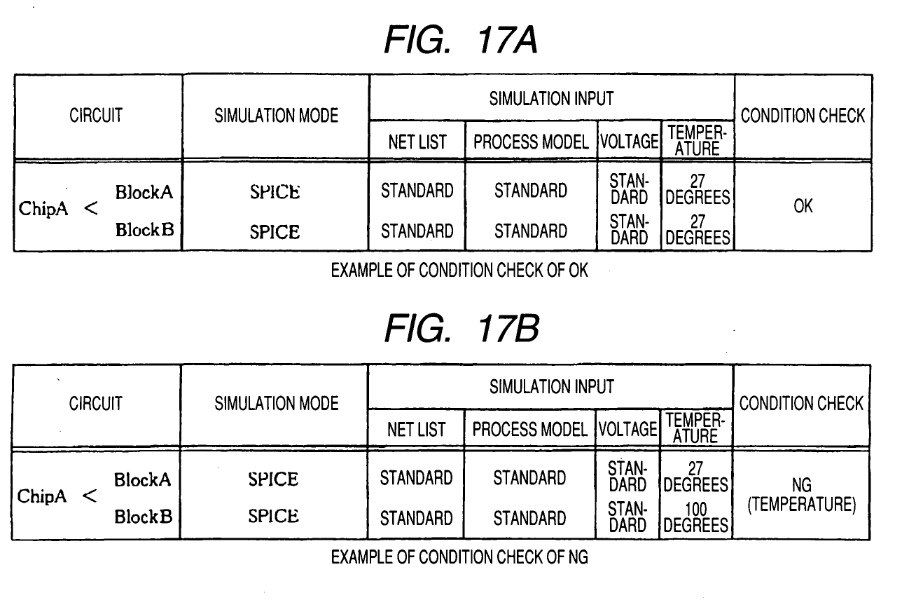

FIG. 17 is a diagram for explaining an example of a condition check according to the embodiment, FIG. 17A showing an example of (OK) which is adapted to the condition check of a simulation and FIG. 17B showing an example of (NG) in which the condition check is not adapted. Since the conditions of temperatures in the blocks A and B of the circuit are different from each other in FIG. 17B, NG is set.

By providing the condition checking portion 37 for ascertaining whether or not conditions are accurately set in the execution of a simulation in each circuit before the execution of the simulation, thus, it is possible to previously ascertain whether or not circuits to be used in the same design phase are mutually subjected to the simulation on the same conditions. Therefore, it is possible to prevent the execution of the simulations in which the conditions of the simulation are not coincident with each other.

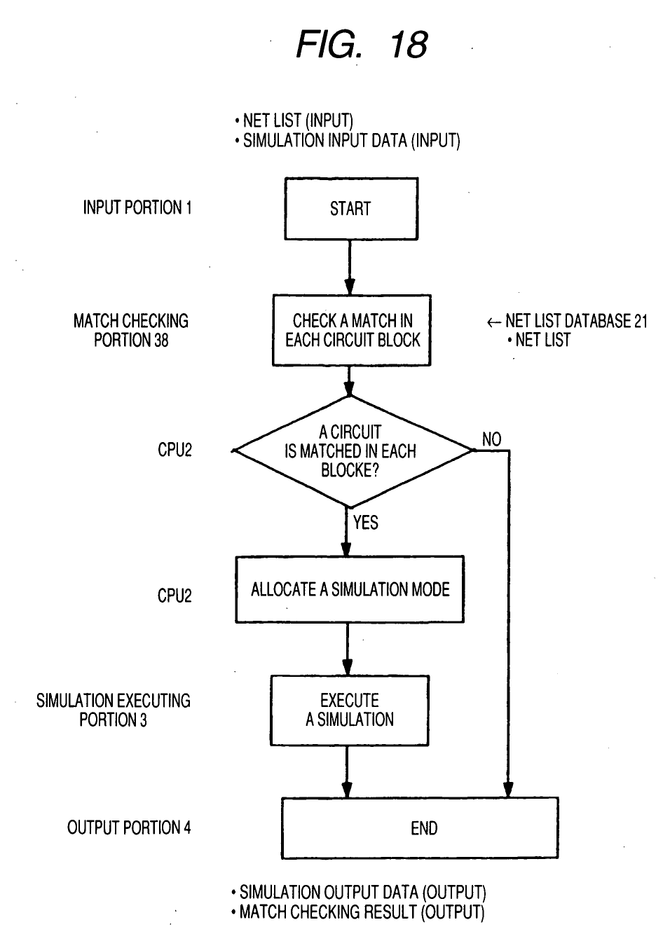

FIG. 18 is a processing flow chart showing the operation of the match checking portion 38 according to the embodiment. The match checking portion 38 carries out match checking in each circuit block for a net list and simulation input data which are input to the input portion 1.

In the case in which the circuits are matched with each other in each block, the CPU 2 allocates a simulation mode in each block, the simulation executing portion 3 executes the simulation, and simulation output data and a matching check result are output from the output portion 4. In the case in which the circuits are not matched with each other in each block, the simulation is not carried out but the matching check result is output from the output portion 4.

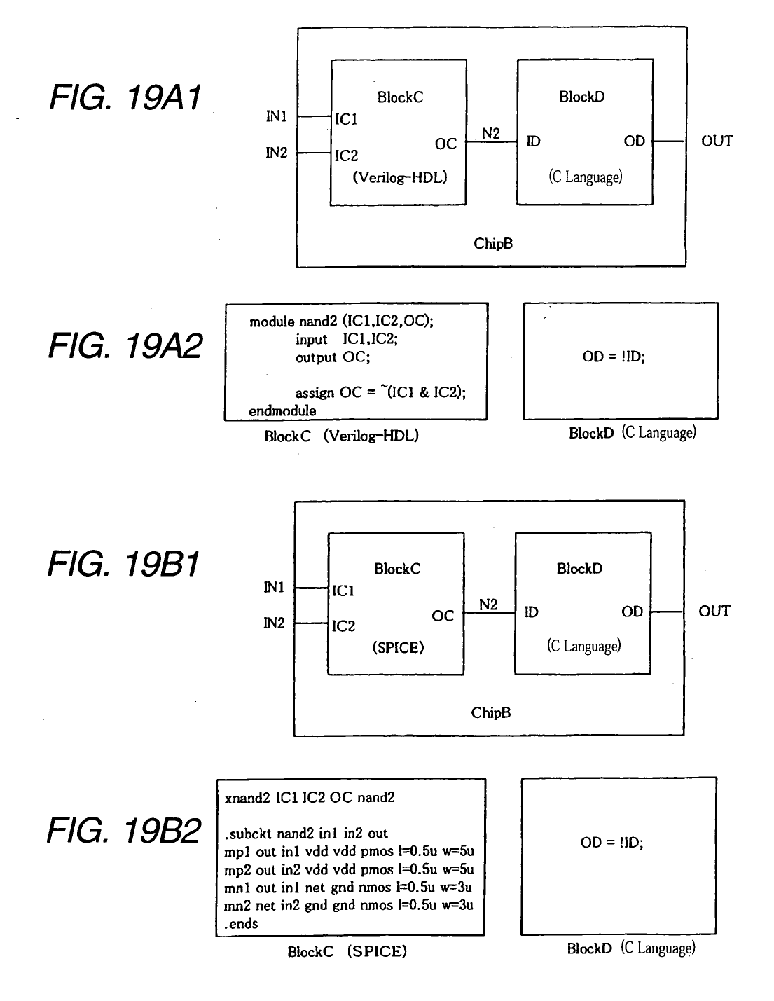

FIGS. 19 to 21 are diagrams for explaining a matching check according to the embodiment. FIG. 19 shows a state in which the circuit design phase 1 and the circuit design phase 2 are matched with each other. FIG. 19A1 is a circuit diagram showing the circuit design phase 1 in which the chip B is constituted by a block C of a 2-input NAND which is described in the Verilog-HDL and a block D of the inverter which is described in the C language. FIG. 19A2 shows the circuit description of the circuit design phase 1 in which the chip B is constituted by the block C of the 2-inpnt NAND which is described in the Verilog-HDL and the block D of the inverter which is described in the C language.

FIG. 19B1 is a circuit diagram showing the circuit design phase 2 in which the chip B is constituted by the block C of the 2-input NAND which is described in the SPICE and the block D of the inverter which is described in the C language. FIG. 19B2 shows the circuit description of the circuit design phase 2 in which the chip B is constituted by the block C of the 2-input NAND which is described in the SPICE and the block D of the inverter which is described in the C language.

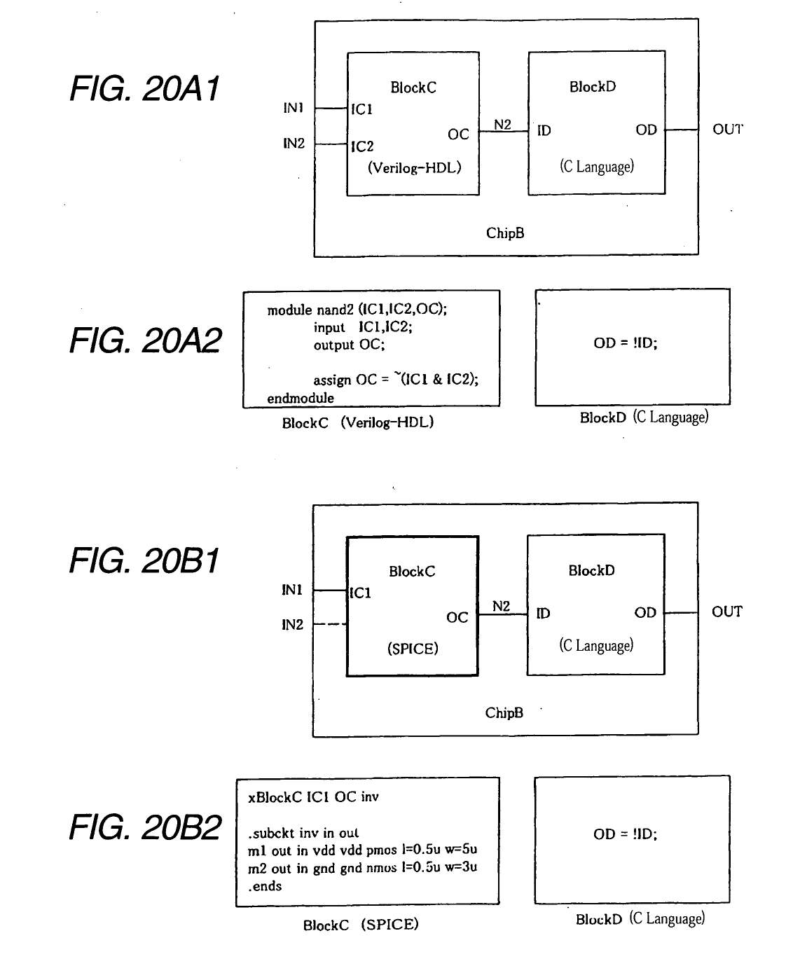

FIG. 20 shows a state in which the circuit design phase 1 and the circuit design phase 2 are not matched with each other. FIG. 20A1 is a circuit diagram showing the circuit design phase 1 in which the chip B is constituted by the block C of the 2-input NAND which is described in the Verilog-HDL and the block D of the inverter which is described in the C language. FIG. 20A2 shows the circuit description of the circuit design phase 1 in which the chip B is constituted by the block C of the 2-input NAND which is described in the Verilog-HDL and the block D of the inverter which is described in the C language.

FIG. 20B1 is a circuit diagram showing the circuit design phase 2 in which the chip B is constituted by the block C of the inverter which is described in the SPICE and the block D of the inverter which is described in the C language. FIG. 20B2 shows the circuit description of the circuit design phase 2 in which the chip B is constituted by the block C of the inverter which is described in the SPICE and the block D of the inverter which is described in the C language.

In the design phase 1 and the design phase 2, the circuits of the blocks C are not matched with each other. More specifically, the fact that the pin of an IC2 in the block C of the circuit design phase 1 is not matched with the circuit design phase 2 is displayed in a heavy line, and the fact that there is no input from an IN2 of the chip B in the block C of the circuit design phase 2 to cause no matching is displayed in a broken line.

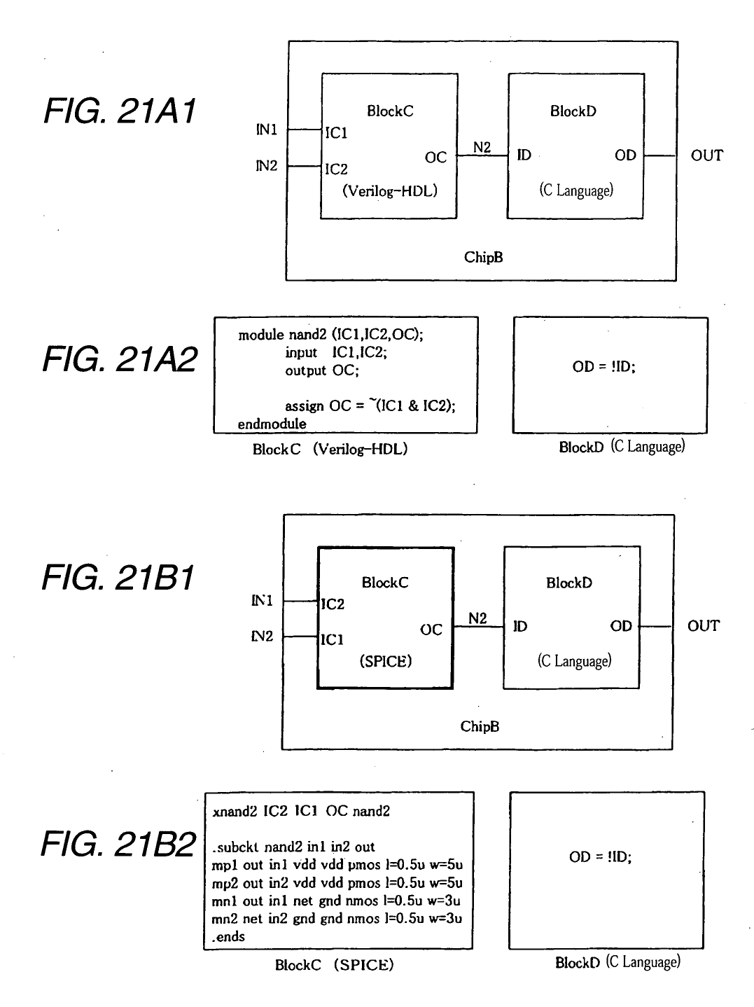

FIG. 21 also shows a state in which the circuit design phase 1 and the circuit design phase 2 are not matched with each other. FIG. 21A1 is a circuit diagram showing the circuit design phase 1 in which the chip B is constituted by the block C of the 2-input NAND which is described in the Verilog-HDL and the block D of the inverter which is described in the C language. FIG. 21A2 shows the circuit description of the circuit design phase 1 in which the chip B is constituted by the block C of the 2-input NAND which is described in the Verilog-HDL and the block D of the inverter which is described in the C language.

FIG. 21B1 is a circuit diagram showing the circuit design phase 2 in which the chip B is constituted by the block C of the 2-input NAND which is described in the SPICE and the block D of the inverter which is described in the C language. FIG. 21B2 shows the circuit description of the circuit design phase 2 in which the chip B is constituted by the block C of the 2-input NAND which is described in the SPICE and the block D of the inverter which is described in the C language.

In the design phase 1 and the design phase 2, the circuits of the blocks C are not matched with each other. More specifically, IN1 and IN2 are connected to IC1 and IC2 in the block C of the circuit design phase 1 respectively, while IN1 and IN2 are connected to IC2 and IC1 in the block C of the circuit design phase 2 respectively and the non-matching with the circuit design phase 1 is displayed in a heavy line.

By providing the match checking portion 38 for ascertaining whether or not the names and numbers of pins are coincident with each other in the circuit blocks before the execution of the simulation, thus, it is possible to prevent the execution of the simulation in a state in which the names, numbers and orders of the pins are different from each other.

As described above, according to the embodiment, firstly, it is not necessary to confirm the output waveforms of the blocks and it is possible to shorten a time taken for detecting a different part by providing the different part detecting portion 31 for detecting the different part of a simulation result.

By providing the difference detecting portion 32 for detecting a difference in a simulation result, secondly, it is possible to detect only a true error portion and to prevent the omission of the detection of the difference from being caused by the executor of the simulation, and furthermore, to shorten a time taken for making a decision whether the difference is set within an allowable range or not.

By providing the input different part display portion 33 for displaying any of circuit shaving different simulation modes input from the input portion which has a difference, thirdly, it is possible to prevent the execution of the simulation in an executing mode which is not intended before the execution of the simulation.

By providing the different part display portion 34 for displaying a circuit having a difference in a simulation result detected by the different part detecting portion 31, fourthly, it is possible to shorten a time taken for analyzing the simulation result.

By providing the condition display portion 35 for displaying, on a circuit diagram, an option to be used in the simulation input from the input portion, fifthly, it is possible to visually decide which option is used for each circuit block, thereby preventing a simulation executing error.

By providing the record managing portion 36 for managing the execution history of a simulation result and the different part of the simulation result, sixthly, it is possible to manage a state in the execution of the simulation and a result beyond mistake even if the simulation mode is used in various combinations for each circuit block.

By providing the condition checking portion 37 for ascertaining whether or not a condition is accurately set in the execution of a simulation in each circuit before the execution of the simulation, seventhly, it is possible to previously ascertain whether or not circuits to be used in the same design phase are mutually subjected to the simulation on the same condition and to prevent the execution of the simulations in which the conditions of the simulation are not coincident with each other.

By providing the match checking portion 38 for ascertaining whether or not the names and numbers of pins are coincident with each other in the circuit blocks before the execution of the simulation, eighthly, it is possible to prevent the execution of the simulation in a state in which the names, numbers and orders of the pins are different from each other.

While the description of the embodiment has been given to the case of the apparatus for designing a semiconductor circuit, it may be given to the case of an apparatus for designing a printed circuit board.

This application is based upon and claims the benefit of priority of Japanese Patent Application No. 2005-057903 filed on Mar. 02, 2005, the contents of which are incorporated herein by reference in its entirety.

The semiconductor designing apparatus according to the invention detects the different part of a simulation result in the simulation modes when selectively switching a simulation mode to be used in each block to be digital or analog corresponding to the progress of a design phase, thereby carrying out the simulation. Consequently, it is not necessary for the executor of the simulation to confirm the output waveforms of the blocks and it is possible to shorten a time taken for detecting a different part. Thus, the semiconductor designing apparatus according to the invention is useful for a semiconductor designing apparatus to be used when designing a semiconductor circuit.

What is claimed is:

1. A semiconductor designing apparatus comprising:
an input portion which inputs data;
a CPU which carries out a data processing;
a simulation executing portion which executes a simulation of a circuit based on the data input from the input portion;
a simulation database which stores a result of the execution of the simulation; and
a different part detecting portion which detects a different part of the result of the simulation.

2. The semiconductor designing apparatus according to claim 1, further comprising a difference detecting portion which detects a difference in the result of the simulation.

3. The semiconductor designing apparatus according to claim 1, further comprising a different part display portion which displays a circuit having a difference in the result of the simulation which is detected by the different part detecting portion.

4. The semiconductor designing apparatus according to claim 1, further comprising a record managing portion which manages an execution history of the result of the simulation and a different part of the result of the simulation.

5. The semiconductor designing apparatus according to claim 1, wherein the different part detecting portion detects the different part of the result of the simulation directly.

6. The semiconductor designing apparatus according to claim 1, further comprising a net list database which stores a net list for carrying out the simulation.

7. The semiconductor designing apparatus according to claim 1, further comprising a circuit diagram database which stores a circuit diagram for carrying out the simulation.

8. The semiconductor designing apparatus according to claim 1, further comprising an input different part display portion which displays any of circuits having different simulation modes which has a difference.

9. The semiconductor designing apparatus according to claim 1, further comprising a condition display portion which displays, on a circuit diagram, an option to be used in the simulation.

10. The semiconductor designing apparatus according to claim 1, further comprising a condition checking portion which ascertains whether or not a condition is accurately set in the execution of the simulation in each circuit before the execution of the simulation.

11. The semiconductor designing apparatus according to claim 1, further comprising a match checking portion which ascertains whether or not names and numbers of pins are coincident with each other in circuit blocks before the execution of the simulation.

12. A semiconductor designing apparatus comprising:
an input portion which inputs data;
a CPU which carries out a data processing;
a simulation executing portion which executes a simulation of a circuit based on the data input from the input portion;
a simulation database which stores a result of the execution of the simulation; and
an input different part display portion which displays any of circuit shaving different simulation modes which has a difference.

13. A semiconductor designing apparatus comprising:
an input portion which inputs data;
a CPU which carries out a data processing;
a simulation executing portion which executes a simulation of a circuit based on the data input from the input portion;
a simulation database which stores a result of the execution of the simulation; and
a condition display portion which displays, on a circuit diagram, an option to be used in the simulation.

14. A semiconductor designing apparatus comprising:
an input portion which inputs data;
a CPU which carries out a data processing;
a simulation executing portion which executes a simulation of a circuit based on the data input from the input portion;
a simulation database which stores a result of the execution of the simulation; and
a condition checking portion which ascertains whether or not a condition is accurately set in the execution of the simulation in each circuit before the execution of the simulation.

15. A semiconductor designing apparatus comprising:
an input portion which inputs data; a CPU which carries out a data processing;
a simulation executing portion which executes a simulation of a circuit based on the data input from the input portion;
a simulation database which stores a result of the execution of the simulation; and
a match checking portion which ascertains whether or not names and numbers of pins are coincident with each other in circuit blocks before the execution of the simulation.
